(19) United States
(12) Patent Application Publication
(10) Pub. No.: US 2025/0184828 A1
(43) Pub. Date: Jun. 5, 2025

(54) METHOD AND APPARATUS FOR TIME INFORMATION OF NTN STORE AND FORWARD OPERATION IN A WIRELESS COMMUNICATION SYSTEM

(71) Applicant: ASUS Technology Licensing Inc., Taipei City (TW)

(72) Inventor: Meng-Hui Ou, Taipei City (TW)

(21) Appl. No.: 18/964,257

(22) Filed: Nov. 29, 2024

Related U.S. Application Data
(60) Provisional application No. 63/604,605, filed on Nov. 30, 2023.

(51) Int. Cl. H04W 28/14; H04W 48/02; H04W 84/06

(52) U.S. Cl. CPC H04W 28/14; H04W 48/02; H04W 84/06

(57) ABSTRACT

Methods, systems, and apparatuses are provided for time information of Non-Terrestrial Network (NTN) store and forward operations in a wireless communication system such that User Equipment (UE) can apply Store and Forward (S&F) operations more efficiently, wherein a method of a UE comprises receiving a time information for an S&F operation for an NTN cell, and determining when to enter or leave an S&F mode for the NTN cell based on the time information.

### CROSS-REFERENCE TO RELATED APPLICATIONS

The present application claims priority to and the benefit of U.S. Provisional Patent Application Ser. No. 63/604,605, filed Nov. 30, 2023, which is fully incorporated herein by reference.

### FIELD

This disclosure generally relates to wireless communication networks and, more particularly, to a method and apparatus for time information of Non-Terrestrial Network (NTN) store and forward operation in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods, systems, and apparatuses are provided for time information of Non-Terrestrial Network (NTN) store and forward operation in a wireless communication system such that User Equipment (UE) can apply Store and Forward (S&F) operation more efficiently. In various embodiments, a method of a UE comprises receiving a time information for an S&F operation for an NTN cell, and determining when to enter or leave an S&F mode for the NTN cell based on the time information.

In various embodiments, a method for an NTN cell in a wireless communication system comprises transmitting a time information for an S&F operation.

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5 is a reproduction of FIGS. 4.1-1: Non-terrestrial network typical scenario based on transparent payload, from 3GPP TR 38.821 V16.0.0

FIG. 6 is a reproduction of FIGS. 4.1-2: Non-terrestrial network typical scenario based on regenerative payload, from 3GPP TR 38.821 V16.0.0.

FIG. 7 is a reproduction of FIG. 5.2.1-1: Regenerative satellite without ISL, gNB processed payload, from 3GPP TR 38.821 V16.0.0.

FIG. 8 is a reproduction of FIG. 5.2.1-2: Regenerative satellite with ISL, gNB processed payload, from 3GPP TR 38.821 V16.0.0.

FIG. 9 is a reproduction of FIG. 5.2.2-1: NG-RAN with a regenerative satellite based on gNB-DU, from 3GPP TR 38.821 V16.0.0.

FIG. 10 is a reproduction of Figure A-1: Illustration of “normal/default operation” and “S&F operation” modes in a 5G system with satellite access, from 3GPP TR 22.865 V2.0.0.

FIG. 11 is a reproduction of FIG. 5.4.3-1: Animal tracking in the remote areas, from 3GPP TR 22.865 V2.0.0.

FIG. 12 is a reproduction of the potential call flow for intermittent feeder link figure from 3GPP RWS-230178.

FIG. 13 is a reproduction of FIG. 4.2.3-1: Non-Roaming 5G System Architecture, from 3GPP TS 23.501 V18.1.0.

FIG. 14 is a diagram showing an example illustration of an NTN network, in accordance with embodiments of the present invention.

FIG. 15 is a diagram showing an example of an S&F mode to a normal mode, in accordance with embodiments of the present invention.

FIG. 16 is a diagram showing an example of a normal mode to an S&F mode, in accordance with embodiments of the present invention.

FIG. 17 is a flow diagram of a method of a UE in a wireless communication system comprising receiving an information to derive time for S&F operation, and determining whether to perform an action based on the information, in accordance with embodiments of the present invention.

FIG. 18 is a flow diagram of a method of a first network node in a wireless communication system comprising transmitting an information to derive a time for S&F operation to a UE, and performing the S&F operation at the time indicated by the information, in accordance with embodiments of the present invention.

FIG. 19 is a flow diagram of a method of a UE in a wireless communication system comprising receiving a time information for an S&F operation for an NTN cell, and determining when to enter or leave an S&F mode for the NTN cell based on the time information, in accordance with embodiments of the present invention.

FIG. 20 is a flow diagram of a method of an NTN cell in a wireless communication system comprising transmitting a time information for an S&F operation, in accordance with embodiments of the present invention.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WIMAX®, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: [1] 3GPP TR 38.821 V16.0.0, “Solutions for NR to support non-terrestrial networks (NTN)”; [2] 3GPP TR 22.865 V2.0.0, “Study on satellite access Phase 3 (Release 19)”; [3] 3GPP TS 23.501 V18.1.0, “System architecture for the 5G system (5GS)”; and [4] 3GPP RWS-230178, “NR and IoT NTN”. The standards and documents listed above are hereby expressly and fully incorporated herein by reference in their entirety.

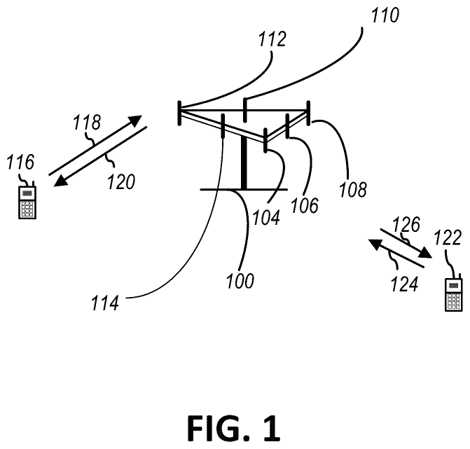

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

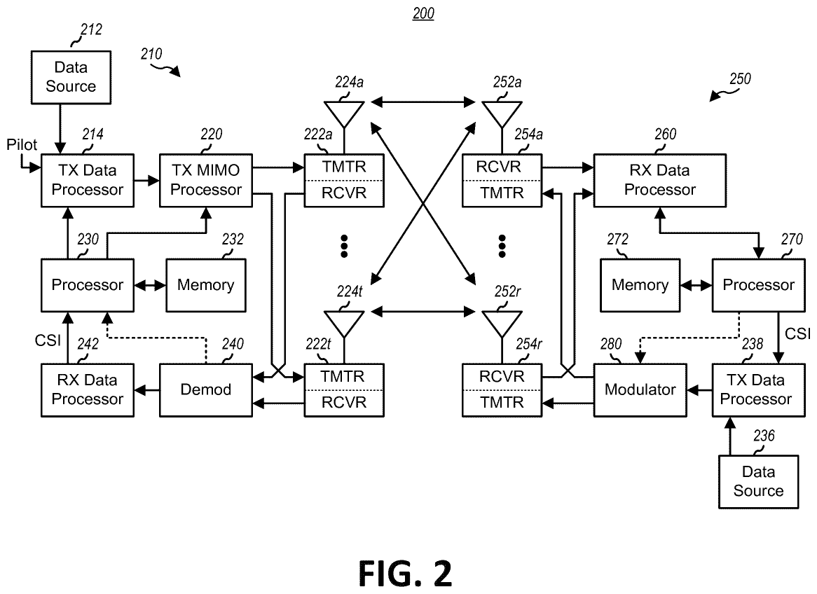

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230. A memory 232 is coupled to processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by NR antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the NR received symbol streams from NR receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

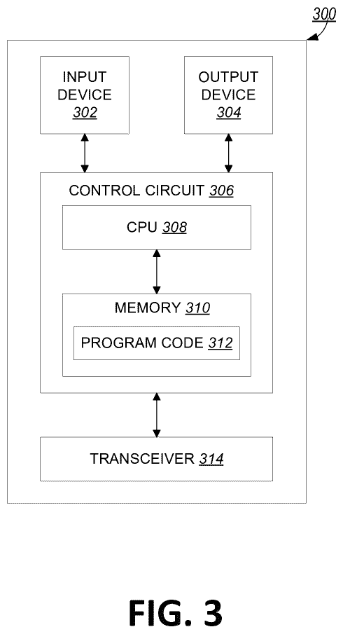

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

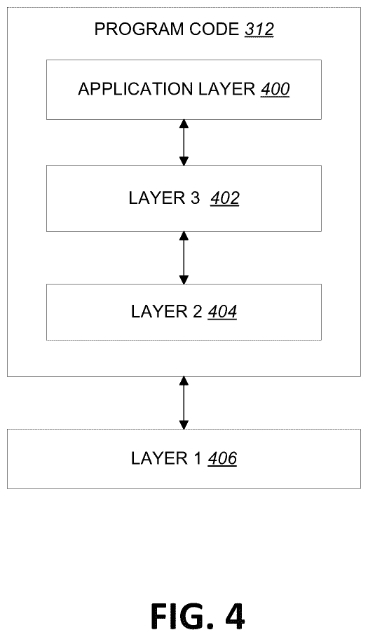

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or NR systems, the Layer 2 portion 404 may include a Radio Link Control (RLC) layer and a Medium Access Control (MAC) layer. The Layer 3 portion 402 may include a Radio Resource Control (RRC) layer.

Any two or more than two of the following paragraphs, (sub-)bullets, points, actions, or claims described in each invention paragraph or section may be combined logically, reasonably, and properly to form a specific method.

Any sentence, paragraph, (sub-)bullet, point, action, or claim described in each of the following invention paragraphs or sections may be implemented independently and separately to form a specific method or apparatus. Dependency, e.g., “based on”, “more specifically”, “example”, etc., in the following invention disclosure is just one possible embodiment which would not restrict the specific method or apparatus.

In 3GPP TR 38.821 ([1] 3GPP TR 38.821 V16.0.0), study on NR NTN (non-terrestrial networks) is introduced. NTN is defined as networks, or segments of networks, using an airborne or space-borne vehicle to embark a transmission equipment relay node or base station. More descriptions are also specified in [1] 3GPP TR 38.821 V16.0.0:

### 4.1 Non-Terrestrial Networks Overview

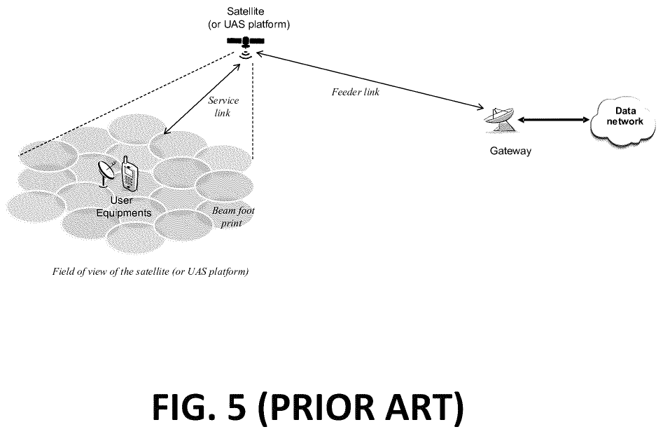

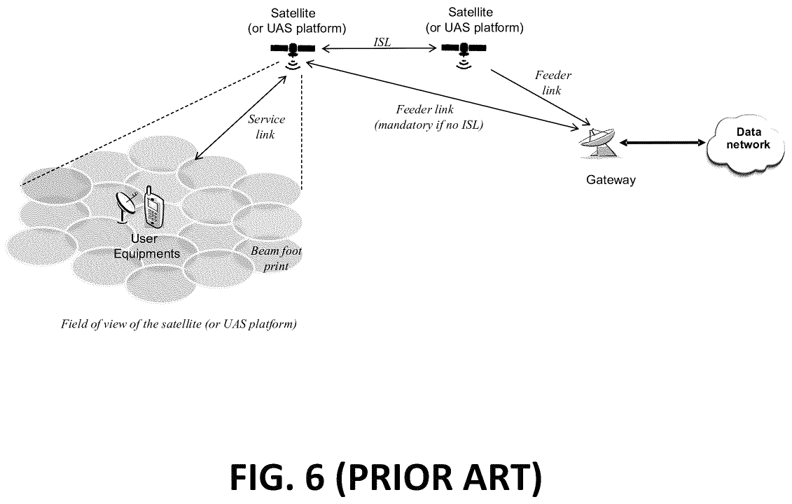

A non-terrestrial network refers to a network, or segment of networks using RF resources on board a satellite (or UAS platform).
The typical scenario of a non-terrestrial network providing access to user equipment is depicted below:
FIG. 5 is a reproduction of FIGS. 4.1-1: Non-terrestrial network typical scenario based on transparent payload, from 3GPP TR 38.821 V16.0.0
FIG. 6 is a reproduction of FIGS. 4.1-2: Non-terrestrial network typical scenario based on regenerative payload, from 3GPP TR 38.821 V16.0.0.
Non-Terrestrial Network typically features the following elements:
One or several sat-gateways that connect the Non-Terrestrial Network to a public data network
   a GEO satellite is fed by one or several sat-gateways which are deployed across the satellite targeted coverage (e.g. regional or even continental coverage). We assume that UE in a cell are served by only one sat-gateway
   A Non-GEO satellite served successively by one or several sat-gateways at a time. The system ensures service and feeder link continuity between the successive serving sat-gateways with sufficient time duration to proceed with mobility anchoring and hand-over
A Feeder link or radio link between a sat-gateway and the satellite (or UAS platform)
A service link or radio link between the user equipment and the satellite (or UAS platform).
A satellite (or UAS platform) which may implement either a transparent or a regenerative (with on board processing) payload. The satellite (or UAS platform) generate beams typically generate several beams over a given service area bounded by its field of view. The footprints of the beams are typically of elliptic shape. The field of view of a satellites (or UAS platforms) depends on the on board antenna diagram and min elevation angle.
   A transparent payload: Radio Frequency filtering, Frequency conversion and amplification. Hence, the waveform signal repeated by the payload is un-changed;
   A regenerative payload: Radio Frequency filtering, Frequency conversion and amplification as well as demodulation/decoding, switch and/or routing, coding/modulation. This is effectively equivalent to having all or part of base station functions (e.g. gNB) on board the satellite (or UAS platform).
Inter-satellite links (ISL) optionally in case of a constellation of satellites. This will require regenerative payloads on board the satellites. ISL may operate in RF frequency or optical bands.
User Equipment are served by the satellite (or UAS platform) within the targeted service area.
   There may be different types of satellites (or UAS platforms) listed here under:

TABLE 4.1-1
Types of NTN platforms

| | | | | Typical beam | |
|---|---|---|---|---|---|
| Platforms | Altitude range | | Orbit | footprint size | |
| Low-Earth Orbit (LEO) | 300-1500 | km | Circular around the earth | 100-1000 | km |
| satellite | | | | | |
| Medium-Earth Orbit | 700025000 | km | | 100-1000 | km |
| (MEO) satellite | | | | | |
| Geostationary Earth | 35 786 | km | notional station keeping | 200-3500 | km |
| Orbit (GEO) satellite | | | position fixed in terms of | | |
| UAS platform (including | 8-50 | km (20 km for HAPS) | elevation/azimuth with respect | 5-200 | km |
| HAPS) | | | to a given earth point | | |
| High Elliptical Orbit | 400-50000 | km | Elliptical around the earth | 200-3500 | km |
| (HEO) satellite | | | | | |

### Typically

GEO satellite and UAS are used to provide continental, regional or local service.
a constellation of LEO and MEO is used to provide services in both Northern and Southern hemispheres. In some case, the constellation can even provide global coverage including polar regions. For the later, this requires appropriate orbit inclination, sufficient beams generated and inter-satellite links.
   HEO satellite systems are not considered in this document.

### 5.2 Regenerative Satellite Based NG-RAN Architectures

### 5.2.1 gNB Processed Payload

### 5.2.1.1 Overview

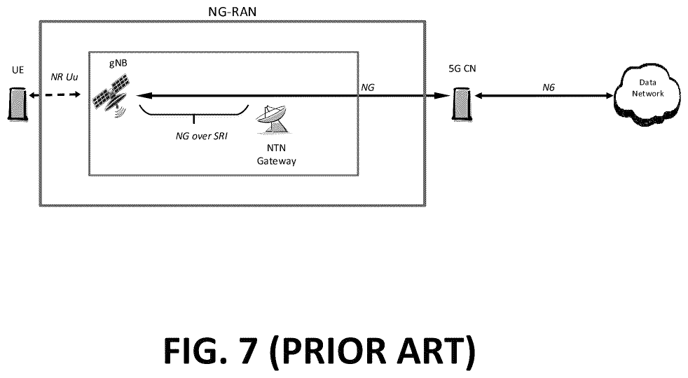

The NG-RAN logical architecture as described in TS 38.401 is used as baseline for NTN scenarios.
The satellite payload implements regeneration of the signals received from Earth.
NR-Uu radio interface on the service link between the UE and the satellite
Satellite Radio Interface (SRI) on the feeder link between the NTN gateway and the satellite.
   SRI (Satellite Radio Interface) is a transport link between NTN GW and satellite.
   FIG. 7 is a reproduction of FIG. 5.2.1-1: Regenerative satellite without ISL, gNB processed payload, from 3GPP TR 38.821 V16.0.0.

NOTE: The satellite may embark additional traffic routing functions that are out of RAN scope.

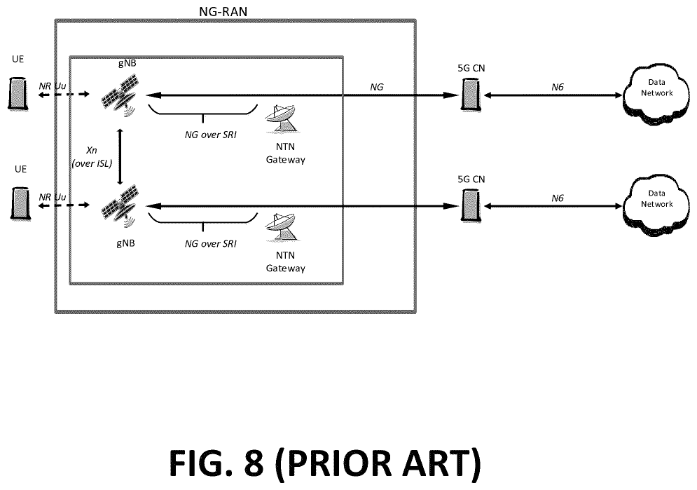

The satellite payload also provides Inter-Satellite Links (ISL) between satellites
ISL (Inter-Satellite Links) is a transport link between satellites. ISL may be a radio interface or an optical interface that may be 3GPP or non 3GPP defined but this is out of the study item scope.
The NTN GW is a Transport Network Layer node, and supports all necessary transport protocols.
FIG. 8 is a reproduction of FIG. 5.2.1-2: Regenerative satellite with ISL, gNB processed payload, from 3GPP TR 38.821 V16.0.0.
The figure above illustrates that UE served by a gNB on board a satellite could access the 5GCN via ISL.
The gNB on board different satellites may be connected to the same 5GCN on the ground.
If the satellite hosts more than one gNB, the same SRI will transport all the corresponding NG interface instances.
5.2.2 gNB-DU Processed Payload

### 5.2.2.1 Overview

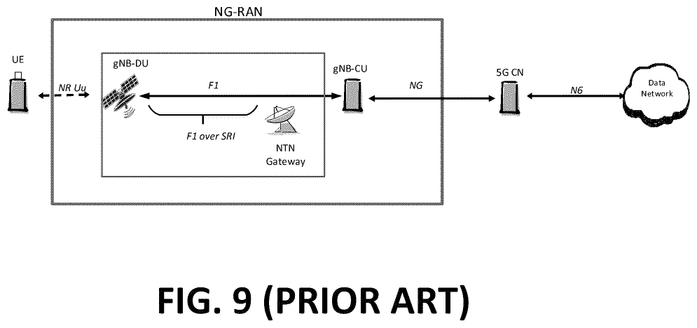

The NG-RAN logical architecture with CU/DU split as described in TS 38.401 is used as baseline for NTN scenarios.
The satellite payload implements regeneration of the signals received from Earth.
NR-Uu radio interface on the service link between the satellite and the UE
Satellite Radio Interface (SRI) on the feeder link between the NTN gateway and the satellite. The SRI transports the F1 protocol.
   The satellite payload may provide inter-satellite links between satellites.
   SRI (Satellite Radio Interface) are transport links; the logical interface F1 that they transport are 3GPP-specified.
   The NTN GW is a Transport Network Layer node, and supports all necessary transport protocols.
   DU on board different satellites may be connected to the same CU on ground.
   If the satellite hosts more than one DU, the same SRI will transport all the corresponding F1 interface instances.
   FIG. 9 is a reproduction of FIG. 5.2.2-1: NG-RAN with a regenerative satellite based on gNB-DU, from 3GPP TR 38.821 V16.0.0.

In 3GPP TR 22.865 ([2] 3GPP TR 22.865 V2.0.0), store & forward (S&F) operation is introduced. The S&F is an operation mode of a 5G system with satellite-access where the 5G system can provide some level of service (in storing and forwarding the data) when satellite connectivity is intermittently/temporarily unavailable, e.g. to provide communication service for UEs under satellite coverage without a simultaneous active feeder link connection to the ground segment.

More details including use cases and potential requirements for S&F operation are also specified in [2] 3GPP TR 22.865 V2.0.0:

### Annex A (Informative):

### Store and Forward Satellite Operation

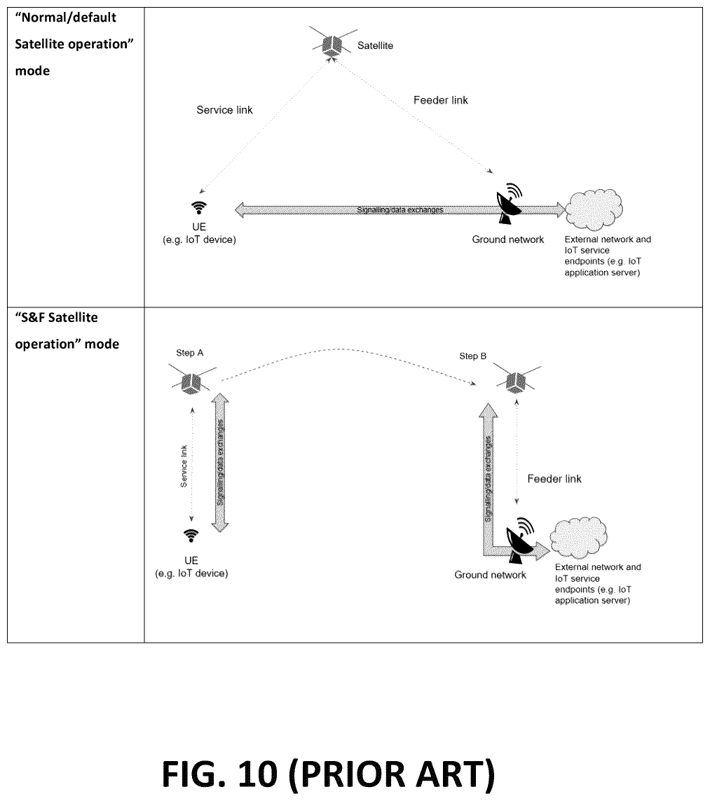

The Store and Forward Satellite operation in a 5G system with satellite access is intended to provide some level of communication service for UEs under satellite coverage with intermittent/temporary satellite connectivity (e.g. when the satellite is not connected via a feeder link or via ISL to the ground network) for delay-tolerant communication service.
An example of “S&F Satellite operation” is illustrated in Figure A-1, in contrast to what could be considered the current assumption for the “normal/default Satellite operation” of a 5G system with satellite access.
As shown in Figure A-1:
Under “normal/default Satellite operation” mode, signalling and data traffic exchange between a UE with satellite access and the remote ground network requires the service and feeder links to be active simultaneously, so that, at the time that the UE interacts over the service link with the satellite, there is a continuous end-to-end connectivity path between the UE, the satellite and the ground network.
In contrast, under “S&F Satellite operation” mode, the end-to-end exchange of signalling/data traffic is now handled as a combination of two steps not concurrent in time (Step A and B in Figure A-1). In Step A, signalling/data exchange between the UE and the satellite takes place, without the satellite being simultaneously connected to the ground network (i.e. the satellite is able to operate the service link without an active feeder link connection). In Step B, connectivity between the satellite and the ground network is established so that communication between the satellite and the ground network can take place. So, the satellite moves from being connected to the UE in step A to being connected to the ground network in step B.
   FIG. 10 is a reproduction of Figure A-1: Illustration of “normal/default operation” and “S&F operation” modes in a 5G system with satellite access, from 3GPP TR 22.865 V2.0.0.
   The concept of “S&F” service is widely used in the fields of delay-tolerant networking and disruption-tolerant networking. In 3GPP context, a service that could be assimilated to an S&F service is SMS, for which there is no need to have an end-to-end connectivity between the end-points (e.g. an end-point can be a UE and the other an application server) but only between the end-points and the SMSC which acts as an intermediate node in charge of storing and relying.
   The support of S&F Satellite operation is especially suited for the delivery of delay-tolerant/non-real-time IoT satellite services with NGSO satellites.

### 5.1 Use Case on Store and Forward—MO

### 5.1.1 Description

This use case illustrates the realization of a S&F service between a UE with satellite access and an Application Server for a delay-tolerant/non-real-time IoT NTN service in the case of a Mobile Originated message.
A description of store and forward operation is provided in Annex A.
Company TrackingInc offers a service of remote monitoring of fields and deploys and tracks many battery-powered IoT type UEs across the globe. All the IoT remote monitoring UEs deployed include a 5G communication with satellite access. Some of the UEs are deployed in a remote area where there is no mobile coverage by MNO and only satellite is possible.
For the satellite access, TrackingInc uses the service of IoTSAT for the 5G IoT connectivity by satellite and IoTSAT uses a LEO constellation which supports S&F operation mode.
All IoT remote monitoring UEs regularly send information related to the area they are monitoring to the application server of TrackingInc and sometimes receive new parameters from the application server. In most of the cases, the messages exchanged are delay-tolerant/non-real-time IoT.

### 5.1.2 Pre-Conditions

In the present use case, the IoT remote monitoring UE is in a remote area with no ground stations available for feeder link connectivity and the IoT remote monitoring UE is aware that IoTSAT constellation operates in S&F mode.

### 5.1.3 Service Flows

The IoT remote monitoring UE needs to send a message to the TrackingInc application server. The UE waits for satellite network coverage and sends its message when the satellite passes by.
The IoT remote monitoring UE and the satellite providing coverage interact over the service link, allowing the UE to transfer the message to the satellite, which has no connectivity to the ground segment. And consequently, the satellite has to store locally the received message.
At this point:
1. Limitations to the size/amount of data that can be sent from the UE could be enforced.
2. Forwarding priority for the stored data to the ground station and data retention period for the exchanged data could be established.
3. Acknowledgement of the received data by the satellite could be issued.
   At a later time, the satellite with the stored message establishes connectivity with the ground network via a feeder link and relays/forwards/downloads the message to the ground network. All accumulated and stored MO messages are delivered to the ground once the feeder link is available, at the same time, all accumulated and stored relevant MT messages are also delivered to the satellite via the same feeder link, which will impact the performance of the feeder link, 5GC, and satellite significantly. The relevant performance optimization method will be taken into consideration accordingly.
   The ground network, based on established connectivity configuration and routing, delivers message to the TrackingInc application server.

### 5.1.4 Post-Conditions

The message generated by the IoT remote monitoring UE has been either delivered successfully to the TrackingInc application server without relying on a continuous end-to-end network connectivity path between them or, in case the data retention period has been exceeded, the message has been discarded.

### 5.2 Use Case on Store and Forward—MT

### 5.2.1 Description

This use case illustrates the realization of a S&F service between a UE with satellite access and an Application Server for a delay-tolerant/non-real-time IoT NTN service in the case of a Mobile Terminated message.
A description of store and forward operation is provided in Annex A.
Company TrackingInc offers a service of remote monitoring of fields and deploys and tracks many battery-powered IoT type UEs across the globe. All the IoT remote monitoring UEs deployed include a 5G communication with satellite access. Some of the UEs are deployed in a remote area where there is no mobile coverage by MNO and only satellite is possible.
For the satellite access, TrackingInc uses the service of IoTSAT for the 5G IoT connectivity by satellite and IoTSAT uses a LEO constellation which supports S&F operation mode.
All IoT remote monitoring UEs regularly send information related to the area they are monitoring to the application server of TrackingInc and sometimes receive new parameters from the application server. In most of the cases, the messages exchanged are delay-tolerant/non-real-time IoT.

### 5.2.2 Pre-Conditions

In the present use case, the IoT remote monitoring UE is in a remote area with no ground stations available for feeder link connectivity and the IoT remote monitoring UE is aware that IoTSAT constellation operates in S&F mode.

### 5.2.3 Service Flows

The TrackingInc application server needs to send new parameters to the IoT remote monitoring UE. Based on the information provided by the network, the application server is aware that the communication with UE is in S&F mode.
The TrackingInc application server message will send new parameters through dedicated messages by conventional means (e.g. IP routing, tunnels) to the network entry-point (e.g. a SCEF, PDN-GW, SMSC), and may provide additional information about the delivery priority, the acknowledgement, etc. to the network.
At this point:
4. Limitations on the amount of data to be transferred to the IoT remote monitoring UE could be enforced.
5. Forwarding priority to the UE could be established.
6. Acknowledgement of the received data by the network could be issued to the application server, possibly with the additional information about the store and forward, e.g. estimated time to deliver the messages.
7. End-to-end acknowledgement policy can be established.
   The network stores the message until it can be delivered/relayed to a satellite expected to fly over and provide coverage to the destination IoT remote monitoring UE.
   When the satellite is connected via the feeder link to the ground network, the message is uploaded into the satellite. All accumulated and stored MT messages are uploaded into the satellite via the feeder link. At the same time, all accumulated and stored MO messages are also delivered to 5GC via the same feeder link, which will cause a performance impact on the feeder link, satellite, and 5GC. It needs a performance optimization method here. When flying over the area that the IoT remote monitoring UE is located, the satellite with the stored message triggers paging over the service link for the UE to connect to the network. (How does the satellite knows where to page the UE (e.g., it has to associate a stored data to the location of the UE and its UE identity)? And what happen if UE moves?)
   The stored message is delivered/downloaded from the satellite to the IoT remote monitoring UE. Acknowledgment may be requested/issued. Mechanisms to ensure integrity of the delivered information may be in place.

### 5.2.4 Post-Conditions

The message generated by the TrackingInc application server has been delivered successfully to the IoT remote monitoring UE without relying on a continuous end-to-end network connectivity path between them.

### 5.4 Use Case on Store and Forward—Data Transfer for IoT Devices in Remote Areas

### 5.4.1 Description

Data transfer at remote sites is a very common requirement. Research institutions can obtain data from remote sites for scientific research, e.g. animal tracking [5]. Government agencies can obtain data from remote sites for disaster mitigation and avoidance, e.g. via remote sensing [6]. Commercial companies can obtain data from remote sites for proper resource allocation. Data transmission at many remote sites is delay-insensitive, and satellite coverage does not always ensure that satellites connect to both the service link and the feeder link. In the past 30 years, many scholars have devoted themselves to studying the data transmission problem of remote sites, and developed the store and forward mechanisms to solve the problem [7][8][9].
In remote areas, there is no terrestrial network for various reasons, e.g. it is difficult to build and maintain communication towers. As a result, this makes it challenging to collect information for environmental protection purposes in these areas. For example, sensors installed on animals need to be monitored regularly. In this scenario, the sensors installed on the animals send the status information, e.g. the movements, physiology and surrounding environment of the animals, to the satellite; and the satellite stores the received status information of the animals, and forwards the information to the scientific centre when a feeder link becomes available.

### 5.4.2 Pre-Conditions

EA Science Center has installed sensors (IoT devices) on the animals to collect information for environmental protection purposes in these remote areas. Satelles, the satellite communication operator, has launched the Store & Forward Satellite operation to support the data transferring for the remote areas. EA Science Center has signed contract with Satelles to allow sensors installed on animals to send the status information (e.g. the movements, physiology and surrounding environment of the animals) to the Science Center via satellite.
The satellite and the IoT devices are properly configured with sufficient information, e.g. credential/certificate that is needed for the devices to verify the authenticity of the satellite.

### 5.4.3 Service Flows

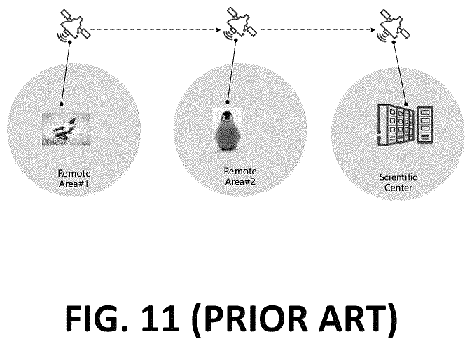

FIG. 11 is a reproduction of FIG. 5.4.3-1: Animal tracking in the remote areas, from 3GPP TR 22.865 V2.0.0.
1. The IoT devices are installed on animals and powered on, they are registered with the 5G network for the Store & Forward Satellite operation. The satellite with the store and forward function enables the IoT devices to transfer data to the network, even when the feeder link to the ground is not available. A secured connection between an IoT device and the satellite is established to protect the data security and privacy.
2. The IoT devices send sensor status information to the satellite, the satellite stores the sensor status information received from the IoT devices.
3. When the satellite has the feeder link available to the ground segment, the satellite forwards the sensor status information, as well as other necessary information, to the ground core network. The ground core network verifies the IoT devices based on the information received; if it is allowed, the ground core network forwards the sensor status information to its destination data network.
4. The ground core network sends the result of the operation to the satellite (the same satellite or a different one that will pass through the remote area).
5. When the satellite (or next satellite) passes through the remote area, the satellite pages the UE, and based on the result received from ground core network, the satellite sends result of the operation to the IoT devices.
6. If an IoT device needs to update the sensor status information, it can send it to the satellite when it is connected to the satellite. The satellite stores it and forwards the sensor status information to the ground core network when feeder link becomes available.

### 5.4.4 Post-Conditions

After the scientific centre receives the sensor status information, the scientists can analyse the sensor status information, and track the status of the animals.

### 5.16 Use Case on Store and Forward—Emergency Report

### 5.16.1 Description

This use case illustrates the realization of a S&F service between a UE with satellite access and an Application Server for an emergency reporting service.
A description of store and forward operation is provided in Annex A.
Bob was sailing on an intercontinental containership, which sank for some exotic reason. Bob is now shipwrecked on a remote island and while he is not in immediate danger, he needs rescue within a matter of days as food and water is scarce.
A few items from the containership washed ashore with Bob, one of which is an IoT device from Company TrackingInc with a subscription to IoTSAT for the 5G IoT connectivity by satellite and IoTSAT is using a LEO constellation which supports S&F operation mode.
The IoT device allows Bob to send an emergency report including his position via the S&F network. A confirmation is received by the IoT device that the emergency report “went through” as soon as possible. As the indicator light by the emergency button of the IoT device starts blinking green, Bob knows that it is a matter of time before Alice rescues him.

### 5.16.2 Pre-Conditions

In the present use case, the emergency reporting UE is in a remote area with no ground stations available for feeder link connectivity and the emergency reporting UE is aware that IoTSAT constellation operates in S&F mode.

### 5.16.3 Service Flows

1. Bob is sailing on an intercontinental containership, which sinks.
2. Bob is ashore and finds an IoT device from Company TrackingInc with a subscription to IoTSAT for the 5G IoT connectivity by satellite.
3. Bob sends an emergency report including his position with the IoT device from Company TrackingInc through IoTSAT.
4. The emergency report from Bob is received by the fly-by satellite of the IoTSAT constellation and is stored in the satellite waiting to be delivered as there is no feeder link available in the area where Bob is ashore.
5. The satellite of the IoTSAT constellation is able to deliver the “emergency report” from Bob in a matter of seconds as soon as a first feeder link is available as it identified the service as emergency and there is no restriction to use any feeder link and ground station for such service.
6. Bob is informed that the emergency report has been delivered upon the next fly-by of a satellite from the IoTSAT constellation.

### 5.16.4 Post-Conditions

The emergency report generated by the IoT UE has been delivered successfully to the TrackingInc application server and forwarded to a service able to treat the report and a response has been forwarded to the IoT UE without relying on a continuous end-to-end network connectivity path between them.

### 6.2 Store & Forward Satellite Operation

The potential requirements corresponding to the support of Store & Forward Satellite information are listed in the table below.

TABLE 6.2-1
Consolidated Requirements for Store & Forward Satellite operation

| CPR # | Consolidated Potential Requirement | Original PR # | Comment |
|---|---|---|---|
| CPR 6.2-1 | Subject to operator's policies, a 5G system with | [PR 5.1.6-001] | |
| | satellite access shall be able to support Store & | [PR.5.3.6-001] | |
| | Forward Satellite operation for authorized UEs e.g. | [PR 5.4.6-001] | |
| | store data on the satellite when the feeder link is | | |
| | unavailable; and forward the data when feeder link | | |
| | between the satellite and the ground segment is | | |
| | available. | | |
| CPR 6.2-2 | A 5G system with satellite access shall be able to | [PR 5.1.6-002] | |
| | inform a UE whether Store & Forward Satellite | | |
| | operation is applied. | | |
| CPR 6.2-3 | Subject to operator's policies, a 5G system with | [PR 5.1.6-003] | |
| | satellite access supporting Store & Forward Satellite | [PR 5.2.6-002] | |
| | operation shall be able to allow the operator or a | | |
| | trusted 3rd party to apply, on a per UE and/or satellite | | |
| | basis, an S&F data retention period. | | |
| CPR 6.2-4 | Subject to operator's policies, a 5G system with | [PR 5.1.6-004] | |
| | satellite access supporting Store & Forward Satellite | [PR 5.2.6-003] | |
| | operation shall be able to allow the operator or a | [PR.5.3.6-003] | |
| | trusted 3rd party to apply, on a per UE and/or satellite | [PR 5.4.6-004] | |
| | basis, an S&F data storage quota. | | |
| CPR 6.2-5 | A 5G system with satellite access supporting Store & | [PR 5.1.6-005] | |
| | Forward Satellite operation shall be able to support a | [PR 5.2.6-004] | |
| | mechanism to configure and provision specific | | |
| | required QoS and policies for UE's data subject to | | |
| | store and forward operation (e.g. forwarding priority, | | |
| | acknowledgment policy). | | |
| CPR 6.2-6 | A 5G system with satellite access supporting Store & | [PR.5.16.6-001] | |
| | Forward Satellite operation shall be able to inform an | | |
| | authorized UE about how long the data received from | | |
| | the UE is expected to be stored before being | | |
| | delivered. | | |
| CPR 6.2-7 | A 5G system with satellite access shall be able to | [PR 5.2.6-001] | Missing similar mention |
| | inform an authorised 3rd party whether Store & | [PR 5.2.6-005] | of the estimated delivery |
| | Forward Satellite operation is applied for | | time for MO use case (in |
| | communication with a UE and to provide information | | CPR 6.2-6) |
| | associated (e.g. estimated delivery time to the UE). | | |

In [4] 3GPP RWS-230178, it is specified that on top of discontinuous coverage, there could also be intermittent feeder link (FL) connectivity with the ground station (GS) in areas where it is not feasible to deploy a ground station or where deployment of ground station is not cost effective. A potential call flow for intermittent feeder link is specified:

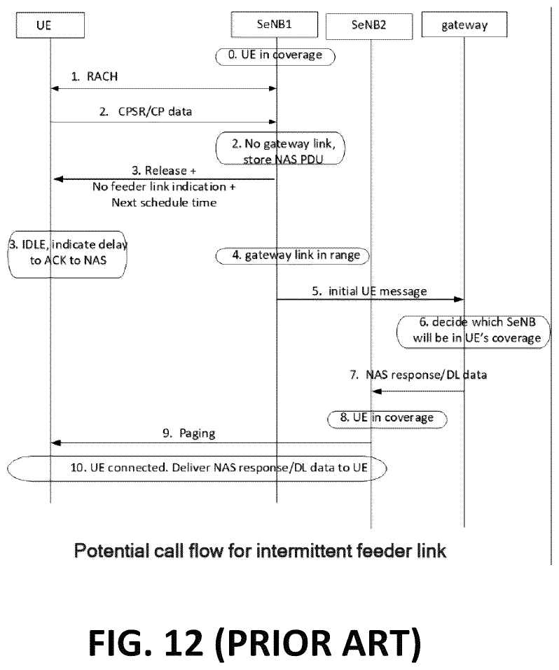

FIG. 12 is a reproduction of the potential call flow for intermittent feeder link figure from 3GPP RWS-230178.

In 3GPP TS 23.501 ([3] 3GPP TS 23.501 V18.1.0), 5G system architecture is illustrated:

### 4.2.3 Non-Roaming Reference Architecture

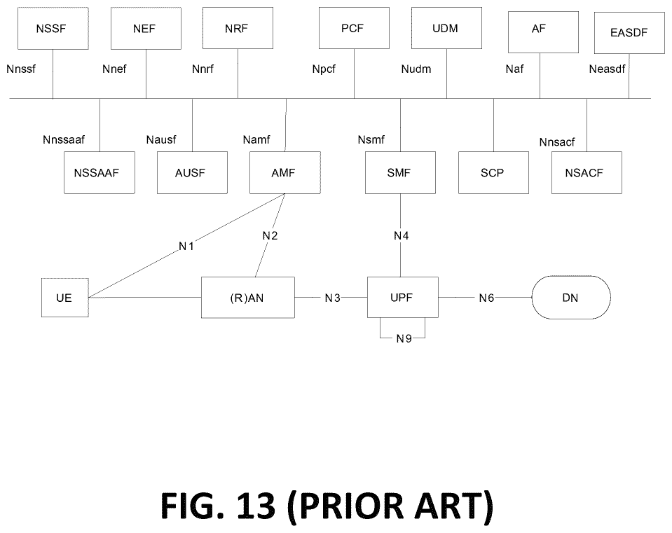

FIG. 4.2.3-1 depicts the non-roaming reference architecture. Service-based interfaces are used within the Control Plane.
FIG. 13 is a reproduction of FIG. 4.2.3-1: Non-Roaming 5G System Architecture, from 3GPP TS 23.501 V18.1.0.

Non-terrestrial network (NTN) could be referred to as a network which provides non-terrestrial access to User Equipment (UE), e.g., by means of an NTN payload embarked on an airborne or space-borne NTN vehicle and an NTN Gateway. An NTN may comprise one or more network nodes, such as a Next Generation Radio Access Network (NG-RAN) node or a Next Generation Node B (gNB). The UE may link to, camp on, and/or connect to the NTN network for transmission and/or reception.

The NTN may comprise various platforms, including Low Earth Orbit (LEO) satellites, Medium Earth Orbit (MEO) satellites, Highly Elliptical Orbit (HEO) satellites, Geostationary Earth Orbit (GEO) satellites, Geostationary Synchronous Orbit (GSO) satellites, Non-Geostationary Synchronous Orbit (NGSO) satellites, and/or High-Altitude Platform Stations (HAPSs). A LEO satellite could have an earth-fixed beam (e.g. the beam is temporarily fixed on a location during a time period) or an earth-moving beam (e.g. the beam is continuously moving along with the satellite). A LEO satellite could serve/provide earth moving cells (e.g. with earth-fixed beams) and/or (quasi-)earth fixed cells (e.g. with earth-moving beams).

The NTN could offer a wide-area coverage and provide Network (NW) access in the scenario when Terrestrial Networks (TNs) are unfeasible (e.g. a desert, a polar area, and/or on an airplane). More details regarding different NTN platforms can be found in TR 38.821 ([1] 3GPP TR 38.821 V16.0.0).

A Store and Forward (S&F) operation could be considered as an operation mode of satellite-access providing some level of service (in storing and forwarding the data) when satellite connectivity is intermittently/temporarily unavailable, e.g. to provide communication service for UEs under satellite coverage without a simultaneous active feeder link connection to the ground segment.

The network supporting S&F operation may be based on architecture of regenerative payload (e.g., as specified in [1] 3GPP TR 38.821 V16.0.0). The network may comprise a Radio Access Network (RAN) and/or a Core Network (CN). The RAN may comprise one or more RAN node(s). The CN may comprise one or more CN node(s). The RAN (or RAN node) may be (or comprise) an NG-RAN node, a gNB, a gNB-Distributed Unit (DU), a gNB-Central Unit (CU), an Evolved Universal Terrestrial Radio Access Network (E-UTRAN) node, an Evolved Node B (eNB), and/or a base station. The CN (or CN node) may be (or comprise) an Evolved Packet Core (EPC), a Mobility Management Entity (MME), a Serving Gateway (S-GW), a 5G Core (5GC), a User Plane Function (UPF), an Access and Mobility Management Function (AMF), a Session Management Function (SMF), and/or a network node specified in TS 23.501 ([3] 3GPP TS 23.501 V18.1.0).

The network (e.g., 5G system) may be separated into (at least) two parts. One part of the network, comprising one or more network node(s) or network segment(s), may be located on a satellite. The other part of the network, comprising one or more network node(s) or network segment(s), which is not located on a satellite, may be located on the ground. The network node(s) and/or network segment(s) may be one or more network nodes (e.g., RAN node or CN node) and/or a portion and/or a combination of the network node(s) mentioned or not mentioned above. For simplicity, the network, network node(s), and/or network segment(s) located in a satellite (or the related network such as what is mentioned above) may be referred to as a NW on a satellite (or a satellite NW). The network, network node(s), and/or network segment(s) located on the ground (or the related network such as what is mentioned above) may be referred to as a NW on ground (or a ground NW).

For example, the satellite NW may be (or comprise) a RAN (e.g., NG-RAN, gNB, and/or eNB). The ground NW may be (or comprise) a CN (e.g., EPC, 5GC, MME, S-GW, AMF, and/or UPF). For example, the satellite NW may be (or comprise) a gNB-DU. The ground NW may be (or comprise) a gNB-CU and/or one or more CN nodes (e.g., AMF, UPF). For example, the satellite NW may be (or comprise) a RAN (e.g., NG-RAN, gNB, and/or eNB) and/or one or more CN nodes (or segments) (e.g., AMF, UPF, MME, S-GW). The ground NW may be the other one or more CN nodes (or segments) (e.g., excluding the part of the satellite NW).

For example, the satellite NW may be (or comprise) a first part of an MME (e.g., on the satellite). The ground NW may be (or comprise) a second part of an MME (e.g., on the ground). The first part of the MME and the second part of the MME may be different. The first part and the second part of the MME may be mutually exclusive.

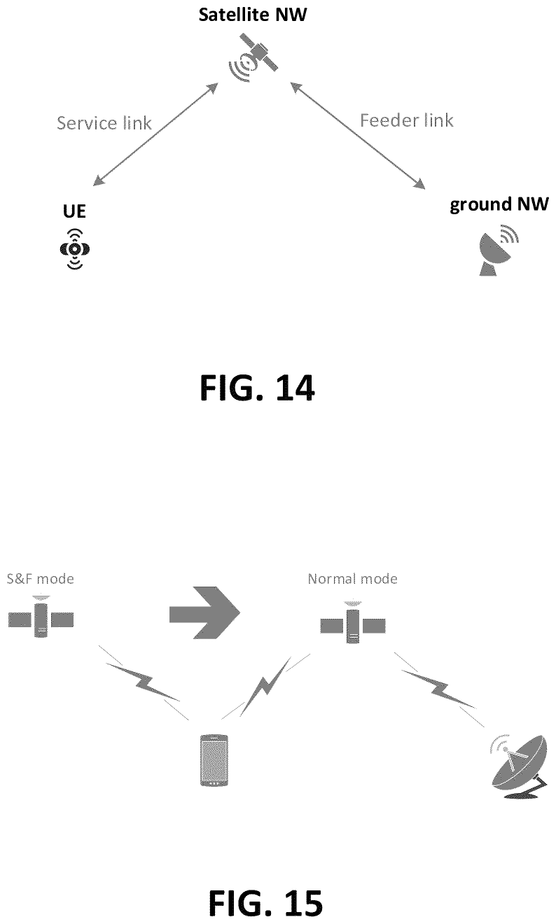

The link/connection/interface between the satellite NW and the ground NW may be referred as a feeder link. The link/connection/interface between the satellite NW and the UE may be referred as a service link. An example is shown in FIG. 14.

Based on TR 22.865 ([2] 3GPP TR 22.865 V2.0.0), there is a requirement that the 5G system with satellite access shall be able to inform a UE that “store and forward” operation is applied. And in [4] 3GPP RWS-230178, a no-feeder-link indication could be included in a release message to the UE. In order for a UE to know whether a satellite network is operating in “store and forward” (S&F) mode, the network may need to provide an indication for the purpose to the UE. When the UE doesn't receive such an indication, the UE may consider the satellite network is not operating in S&F mode, and/or is operating in a normal mode (or default mode).

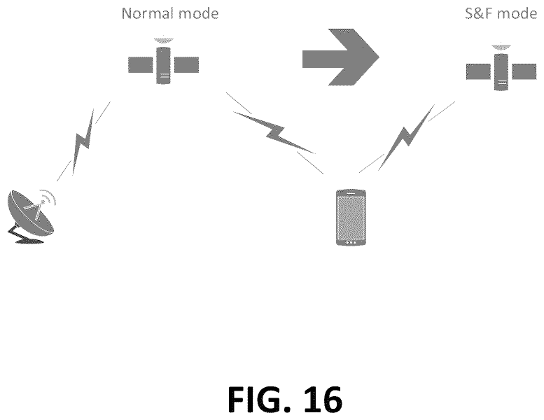

However, the UE can only know the satellite network is changing the operating mode (e.g., S&F mode) upon receiving the indication. The approach of detecting the operation mode (e.g., S&F mode) based on (merely) the indication may have some drawback(s):
For example, considering a case of operation mode switch from S&F mode to normal mode, as shown in FIG. 15, for a UE not supporting S&F operation, the UE may not connect to a cell when the cell is operating in S&F mode (e.g., consider the cell as barred). However, since the UE doesn't know when the cell will switch the operation mode to normal mode, the UE may not connect to the cell promptly after the cell switches to normal mode.
For example, considering a case of operation mode switch from normal mode to S&F mode, as shown in FIG. 16, since a UE doesn't know when the cell will switch to S&F mode, the UE may initiate a Scheduling Request (SR)/Buffer Status Report (BSR) (e.g. upon non-S&F data arrival) at the very end of the normal mode, which may cause useless signaling overhead and power consumption.
For example, if the indication is provided via system information, for a Narrowband Internet of Things (NB-IoT) UE, the UE needs to move to idle mode to re-acquire system information, which also causes extra signaling overhead.

The operation mode of the satellite network may depend on whether the feeder link is available, and the availability of the feeder link may be predictable (e.g., based on the satellite movement on its orbit). It could be beneficial for a UE to know when the satellite network will operate in S&F mode (or switch to S&F mode from the default/normal mode) in advance. Information other than (or in addition to) the indication could be used for the purpose.

The following terminologies may be mutually replaceable: S&F (Store-and-Forward) mode, S&F (Store-and-Forward) operation, and/or non-Real Time (RT) mode.

The following terminologies may be mutually replaceable: normal mode, normal operation, default mode, default operation, RT (real time) mode, RT (real time) operation, non-S&F mode, and/or non-S&F operation.

To solve the issue, (one or more) information that indicates (or is used to derive) time for S&F operation (and/or time related to feeder link) could be provided to a UE. The time for S&F operation may be (or include) the time to start the S&F operation, time to end the S&F operation, and/or duration (or time period) of the S&F operation. The time related to the feeder link may be (or include) the time that the feeder link becomes available, the time that the feeder link becomes not available, and/or the time duration (or period) that the feeder link is not available. The information may be an estimated or expected value. The information may include one or more elements, e.g., time element, feature indication, and/or Boolean bit.

The information may be included in system information (e.g., a System Information Block (SIB)). The information may be included in a dedicated signaling (e.g., a Radio Resource Control (RRC) message, a RRC reconfiguration message). The information may not be ephemeris (e.g., associated to the cell, associated to the network, associated to the satellite). The information may be provided in addition to ephemeris (e.g., associated to the cell, associated to the network, associated to the satellite). The information may be provided in a configuration of NTN.

The network node may provide the information when it is in S&F mode. The network node may provide the information when it is in default mode (or normal mode). The network node may provide the information before it is operating in S&F mode. The network node may provide the information before it enters (or switches to, or enables, or activates) S&F mode (from normal/default mode). The network node may provide the information when the feeder link (of the network node) is not available. The network node may provide the information when the feeder link (of the network node) is available. The network node may provide the information when the service link (of the network node) is available. The network node may be (or comprise, or replaced by) a network, a radio access network, a cell, an NTN cell, a base station, an eNB, a gNB, a satellite, and/or a satellite network.

The information may be for (or associated to, or correspond to) a network (e.g., a satellite network), a network node, a cell (e.g., an NTN cell). The cell may be a serving cell (of the UE). The cell may be a neighbor cell (e.g., of the UE, of the NTN cell).

The UE may receive the information when it is in S&F mode. The UE may receive the information when it is not in S&F mode. The UE may receive the information when it is in normal/default mode. The UE may receive the information before it is operating in S&F mode. The UE may receive the information before it enters (or switches to, or enables, or activates) S&F mode (from normal/default mode). The UE may receive the information when the feeder link (of the UE) is not available. The UE may receive the information when the feeder link (of the UE) is available. The UE may receive the information when the service link (of the UE) is available.

The (one or more) information may indicate or may be used (by the UE) to derive at least one or more of the following:
Time to start S&F operation (or expected to start); and/or
Time to end S&F operation (or expected to end); and/or
(expected/estimated) duration (or time period) of S&F operation; and/or
Time to enter (or enable, or activate) S&F mode (e.g., from default/normal mode); and/or
Time to leave (or disable, or deactivate) S&F mode (e.g., to default/normal mode); and/or
Time to switch operation mode (e.g., between S&F mode and default/normal mode); and/or
Time that the feeder link will be (or become) not available (or expected to be not available); and/or
Time that the feeder link will be (or become) available (or expected to be available); and/or
(expected/estimated) duration (or time period) that the feeder link is not available; and/or
Whether S&F operation is enabled (or not); and/or
Whether S&F operation is allowed (or not); and/or
Whether S&F operation is supported (or not).

More than one information may be provided to the UE. Different information may indicate different information. For example, a first information may indicate the time related to the S&F operation. A second information may indicate the time related to the feeder link status. For example, a first information may indicate the time to switch operation mode. A second information may indicate the duration of an operation mode.

The information may be (or include) an absolute time, a relative time, and/or a time relative to a time reference. For example, the information may be (or include) a time after 00:00:00 on a Gregorian calendar date 1 Jan. 1900 (midnight between Sunday, Dec. 31, 1899 and Monday, Jan. 1, 1900). The information may be indicated in multiples of 10 ms. For example, the information may be (or include) a frame number (e.g., a System Frame Number (SFN) and/or a subframe number).

Based on (at least) the (one or more) information, the UE may determine (whether/when) to apply (or use) an S&F operation. The UE may (determine to) apply the S&F operation, e.g., during a period indicated (or derived) by the information. The UE may (determine to) not apply the S&F operation, e.g., outside (or at least for some time outside) a period indicated (or derived) by the information.

Based on (at least) the (one or more) information, the UE may determine (whether/when) to start the S&F operation (or enter/enable/activate S&F mode). The UE may (determine to) start (applying) the S&F operation, e.g., at a time indicated (or derived) by the information. The UE may (determine to) enter/enable/activate the S&F mode (e.g., from default/normal mode), e.g., at time indicated (or derived) by the information.

Based on (at least) the (one or more) information, the UE may determine (whether/when) to stop the S&F operation (or leave/disable/deactivate S&F mode). The UE may (determine to) stop (applying) the S&F operation, e.g., at a time indicated (or derived) by the information. The UE may (determine to) leave/disable/deactivate the S&F mode (e.g., to default/normal mode), e.g., at a time indicated (or derived) by the information.

Based on (at least) the (one or more) information, the UE may determine (whether/when) to switch an operation mode. The operation mode may include S&F mode, default mode, and/or normal mode. The UE may (determine to) switch to S&F mode (e.g., from normal/default mode), e.g., at a time indicated (or derived) by the information. The UE may switch to normal/default mode (e.g., from S&F mode), e.g., at a time indicated (or derived) by the information.

Based on (at least) the (one or more) information, the UE may determine (whether/when) to apply (at least) a configuration related to S&F. The UE may (determine to) apply (at least) the configuration related to S&F, e.g., at a time indicated (or derived) by the information. The UE may (determine to) start applying (at least) the configuration related to S&F, e.g., at a time indicated (or derived) by the information. The UE may (determine to) release (at least) the configuration related to S&F, e.g., at a time indicated (or derived) by the information. The UE may (determine to) stop applying (at least) the configuration related to S&F, e.g., at a time indicated (or derived) by the information. The S&F configuration may be provided to the UE before the UE uses (or applies) the S&F operation.

Based on (at least) the (one or more) information, the UE may determine (whether) to transmit S&F data. The S&F data may be (or include) delay-tolerant data, small data, data that is allowed to use the S&F operation (or mode), data that can be transmitted or received in S&F mode, and/or data that is configured to use the S&F operation (or mode).

Based on (at least) the (one or more) information, the UE may determine (whether) to allow (or prohibit) S&F data transmission. The UE may (determine to) allow (or prohibit) S&F data transmission, e.g., at a time indicated (or derived) by the information. The UE may (determine to) allow (or prohibit) S&F data transmission, e.g., during a period indicated (or derived) by the information. The UE may (determine to) allow (or prohibit) S&F data transmission, e.g., outside (or at least for some time outside) a period indicated (or derived) by the information.

In one or more examples, if (or when, or in response to) there is S&F data arrival (e.g., becomes available, or pending for transmission) to the UE, the UE may determine (whether) to use or request (uplink) resource(s) for (uplink) data transmission (e.g., for the S&F data). The request may be (or include): a scheduling request, a random access preamble, a connection request, a registration request, a service request, and/or a Protocol Data Unit (PDU) session establishment request.

In one or more examples, if S&F data transmission is ongoing, the UE may determine (whether) to continue (or cancel) the transmission based on the information (or based on S&F indication). If the UE is about to leave S&F mode (e.g., the remaining time before leaving S&F mode is close), the UE may (determine to) continue (or cancel) the transmission. The UE may continue (or cancel) the transmission, e.g., at a time indicated (or derived) by the information (e.g., when the UE leaves/disables/deactivates S&F mode). The UE may continue (or cancel) the transmission when (or in response to, or after) leaving S&F mode.

In one or more examples, if a request is pending, the UE may determine (whether) to continue (or cancel) the request based on the information (or based on S&F indication). If the UE is about to leave/disable/deactivate S&F mode (e.g., the remaining time before leaving S&F mode is close), the UE may (determine to) continue (or cancel) the request. The UE may continue (or cancel) the request, e.g., at a time indicated (or derived) by the information (e.g., when the UE leaves/disables/deactivates S&F mode). The UE may continue (or cancel) the request when (or in response to, or after) leaving S&F mode.

Based on (at least) the (one or more) information, the UE may determine (whether) to transmit non-S&F data. Based on (at least) the (one or more) information, the UE may determine (whether) to request (or use) uplink resource(s) for transmission (e.g., of non-S&F data). Non-S&F data may be (or include) data other than S&F data, non-delay-tolerant data, delay sensitive data, data that is prohibited to use the S&F operation (or mode), data that cannot be transmitted or received in S&F mode, and/or data that is not configured to use the S&F operation (or mode). The request may be (or comprise) an SR, and/or a BSR.

Based on (at least) the (one or more) information, the UE may determine (whether) to allow (or prohibit) non-S&F data transmission. The UE may (determine to) allow (or prohibit) non-S&F data transmission, e.g., at a time indicated (or derived) by the information. The UE may (determine to) allow (or prohibit) non-S&F data transmission, e.g., during a period indicated (or derived) by the information. The UE may (determine to) allow (or prohibit) non-S&F data transmission, e.g., outside (or at least for some time outside) a period indicated (or derived) by the information.

In one or more examples, if there is non-S&F data arrival (e.g., becomes available) to the UE, the UE may determine whether to use uplink resource(s) for the non-S&F data transmission based on the information. If the UE is about to enter/enable/activate S&F mode (e.g., the remaining time before entering/enabling/activating S&F mode is not enough), the UE may (determine to) not use uplink resource(s) for the non-S&F data transmission. The remaining time may be derived by (or based on) (at least) the information.

In one or more examples, if there is non-S&F data arrival (e.g., becomes available) to the UE, the UE may determine (whether) to request uplink resource(s) for the non-S&F data transmission based on the information. If the UE is about to enter/enable/activate S&F mode (e.g., the remaining time before entering/enabling/activating S&F mode is not enough), the UE may (determine to) not request uplink resource(s) for the non-S&F data transmission. The remaining time may be derived by (or based on) (at least) the information. The request may be (or include): a scheduling request, a random access preamble, a connection request, a registration request, a service request, and/or a PDU session establishment request.

In one or more examples, if a request due to (or triggered by) non-S&F data has been triggered (or is pending), the UE may determine (whether) to cancel the request based on the information (or based on S&F indication). If the UE is about to enter/enable/activate S&F mode (e.g., the remaining time before entering/enabling/activating S&F mode is not enough), the UE may (determine to) cancel the request. The UE may cancel the request, e.g., at a time indicated (or derived) by the information (e.g., when the UE enters/enables/activates S&F mode). The UE may cancel the request when (or in response to) entering/enabling/activating S&F mode.

In one or more examples, if non-S&F data transmission is ongoing, the UE may determine (whether) to cancel the transmission based on the information (or based on S&F indication). If the UE is about to enter/enable/activate S&F mode (e.g., the remaining time before entering/enabling/activating S&F mode is not enough), the UE may (determine to) cancel the transmission. The UE may cancel the transmission, e.g., at a time indicated (or derived) by the information (e.g., when the UE enters/enables/activates S&F mode). The UE may cancel the transmission when (or in response to) entering/enabling/activating S&F mode.

Based on (at least) the (one or more) information, the UE may determine (whether) to initiate (or suspend) a specific procedure (and/or function). The UE may (determine to) initiate (or suspend) the specific procedure (and/or function), e.g., at a time indicated (or derived) by the information. The UE may (determine to) initiate (or suspend) the specific procedure (and/or function), e.g., during a period indicated (or derived) by the information. The UE may (determine to) initiate (or suspend) the specific procedure (and/or function), e.g., outside (or at least for some time outside) a period indicated (or derived) by the information.

In one or more examples, if a procedure cannot be initiated in S&F mode (or using S&F operation), and the UE derives the remaining time before entering/enabling/activating S&F mode is not enough (e.g., to complete the procedure), the UE may determine to suspend (or not initiate) the procedure. The remaining time may be derived by (or based on) (at least) the information.

Based on (at least) the (one or more) information, the UE may determine (whether) to allow (or prohibit) a specific procedure (e.g., to be initiated, to be ongoing). The UE may (determine to) allow (or prohibit) the specific procedure (and/or function), e.g., at a time indicated (or derived) by the information. The UE may (determine to) allow (or prohibit) the specific procedure (and/or function), e.g., during a period indicated (or derived) by the information. The UE may (determine to) allow (or prohibit) the specific procedure (and/or function), e.g., outside (or at least for some time outside) a period indicated (or derived) by the information.

In one or more examples, if a procedure is not allowed in S&F mode (or using S&F operation), and the UE derives the remaining time before entering/enabling/activating S&F mode is not enough (e.g., to complete the procedure), the UE may determine to prohibit (or not allow) the procedure. The remaining time may be derived based on the information.

In one or more examples, if a procedure (or function) triggered by (or due to, or based on) non-S&F data is pending (or ongoing), the UE may determine to cancel (or continue) the procedure (or function) based on the information. If the UE is about to enter/enable/activate S&F mode (e.g., the remaining time before entering/enabling/activating S&F mode is not enough), the UE may (determine to) cancel the procedure (or function). The UE may cancel the procedure (or function), e.g., at a time indicated (or derived) by the information (e.g., when the UE enters/enables/activates S&F mode). The UE may cancel the procedure (or function) when (or in response to) entering/enabling/activating S&F mode.

In one or more examples, the UE may determine (whether) to access (or connect to, or camp on, or bar) a cell (or network, or satellite) based on (at least) the (one or more) information. The cell may be a neighbor cell, a candidate cell, and/or a serving cell. The UE may determine the current operation mode of the cell (or network, or satellite) based on the information. The operation mode may be (or comprise) S&F mode, normal mode, and/or default mode. If (at least) the UE determines that the current operation mode is S&F mode, the UE may not access (or connect to, or camp on) the cell (or network, or satellite). If (at least) the UE determines that the current operation mode is S&F mode, the UE may consider the cell (or network, or satellite) as barred. If (at least) the UE determines that the current operation mode is normal mode, the UE may be allowed to access (or connect to, or camp on) the cell (or network, or satellite). If (at least) the UE determines that the current operation mode is normal mode, the UE may not consider the cell (or network, or satellite) as barred. The UE may be a UE not supporting S&F operation.

The specific procedure (or function) may be (or include): an early data transmission, a small data transmission, a random access procedure, a scheduling request (SR), and/or buffer status reporting (BSR).

The specific procedure (or function) may be (or include): a registration (or deregistration) procedure, an attached procedure, a tracking area update procedure, a PDU session establishment (or modification) procedure, a Non-Access Stratum (NAS) transport procedure, a Packet Data Network (PDN) connectivity procedure, and/or a service request procedure.

The specific procedure (or function) may be (or include): an RRC connection establishment procedure, an RRC connection re-establishment procedure, and/or an RRC connection resume procedure.

The specific procedure (or function) may be triggered by (or due to) non-S&F data, e.g., arrival of non-S&F data, non-S&F data becomes available for transmission.

A UE and/or a network node may be in S&F mode (or use S&F operation) if at least one or more of the following conditions are fulfilled:
The feeder link (of the UE and/or the network node) is not available; and/or
An indication of S&F mode (and/or to enable S&F mode) is received (or transmitted); and/or
A configuration related to S&F mode (and/or enabled) is received (or transmitted); and/or
S&F mode (of the UE and/or the network node) is enabled and/or activated.

The UE and/or the network node may be in normal mode (e.g., compared to S&F mode) if at least one or more of the following conditions are fulfilled:
The feeder link (of the UE and/or the network node) is available; and/or
No indication of S&F mode is received (or transmitted); and/or
An indication to disable (or deactivate) S&F mode is received (or transmitted); and/or
No configuration related to S&F mode (and/or enabled) is received (or transmitted); and/or
A configuration to disable (or deactivate) S&F mode is received (or transmitted); and/or
S&F mode (of the UE and/or the network node) is disabled and/or deactivated.

The UE and/or the network node may enter S&F mode from normal mode, and/or leave S&F mode to enter normal mode.

When the UE and/or the network node is in S&F mode (or use S&F operation), at least one or more of the following may be performed:
The UE may know (or be informed by the NW) that the NW is (or starts) using S&F to handle data (and/or signaling); and/or
The UE may initiate a procedure to request (or indicate) the (satellite) NW to use S&F to handle data (and/or signaling); and/or
The UE may perform data (and/or signaling) transmission that will be handled by S&F in the (satellite) NW; and/or
The UE may (be ready to) perform data (and/or signaling) reception that is stored in the (satellite) NW.

One or more configurations (/indication/parameter) related to S&F may be provided to the UE (e.g., from the network node, e.g., in addition to the information). The configuration (and/or the indication/parameter) related to S&F (or S&F configuration) may be associated (or specific) to an object. The object may be (or comprise) a UE, a cell, a connection (e.g., RRC connection, NAS connection), a PDU session, and/or a Quality of Service (QoS) flow. The NW may indicate (or configure) which object that the configuration (and/or the indication/parameter) is associated to. The NW may provide (at least) one configuration (and/or the indication/parameter) to (at least) one object.

The configuration (and/or the indication/parameter) related to S&F may be/comprise/be used for/indicate one or more of the following:

### S&F Mode Indication

The indication may (at least) indicate whether the S&F operation is enabled/configured/activated or not (e.g., in the cell, for the UE, to the NW). The indication may (at least) indicate whether a feeder link of the NW is available or not. The indication may (at least) indicate whether the UE is allowed to use S&F operation (e.g., in the cell, to the NW).

The UE may determine (whether) to use S&F operation based on (at least) the indication. For example, if the UE receives the indication, the UE may consider the S&F operation is enabled (and/or activated). If the UE does not receive the indication, the UE may consider the S&F operation is not enabled (and/or activated). If the UE receives the indication, the UE may be allowed to use the S&F operation. If the UE does not receive the indication, the UE may not be allowed to use the S&F operation. The UE may be of a specific UE type. The UE type is illustrated below.

### UE Type

The configuration may (at least) indicate what (type of) UE is allowed to use S&F operation. The configuration may (at least) indicate what (type of) UE is allowed to perform transmission and/or reception to the NW (e.g., using S&F operation). The transmission and/or reception may be User Plane (UP) data and/or Control Plane (CP) signaling.

The UE type (e.g., a first type) may be based on (or identified by/represented by/specific to) UE capability, UE mobility, QoS characteristics of the UE, UE status. The UE type may be (or comprise) (at least) an enhanced Machine Type Communication ((e)MTC) UE, an NB-IoT UE, a Reduced Capability (RedCap) UE, a UE supporting NR, a UE supporting 5GC, a UE supporting NTN, a UE supporting regenerative payload, a UE with Global Navigation Satellite System (GNSS), and/or a UE supporting S&F operation. The UE type may be (or comprise) (at least) a stationary UE, a low mobility UE, and/or a UE within a limited area. The UE type may be (or comprise) (at least) a UE with a low QoS requirement, and/or a UE without Ultra-Reliable Low-Latency Communication (URLLC).

The configuration may (also) be pre-configured. For example, a first type of UE is allowed to use S&F operation if the UE receives the S&F mode indication. For example, a first type of UE is (always) allowed to use S&F operation.

The UE may determine (whether) to use S&F operation based on (at least) the configuration. For example, if the UE receives the configuration and/or the UE belongs to a UE type in the configuration (or pre-configuration), the UE may consider the S&F operation is enabled (and/or activated, and/or allowed). If the UE receives the configuration and/or the UE does not belong to a UE type in the configuration (or pre-configuration), the UE may consider the S&F operation is not enabled (and/or activated, and/or allowed). If the UE does not receive the configuration, the UE may consider the S&F operation is not enabled (and/or activated, and/or allowed).

### Traffic Type

The configuration may (at least) indicate what (type of) traffic is allowed to use S&F operation. The configuration may (at least) indicate what (type of) traffic is allowed to be transmitted to the NW (e.g., using S&F operation). The traffic may be (UP) data and/or (CP) signaling. The traffic may be Access Stratum (AS) level and/or NAS level. The configuration may (also) be pre-configured. The configuration may be based on a QoS requirement of the traffic (or the traffic type).

The traffic (or the traffic type) may be based on (or identified by/represented by/specific to) a QoS flow, a PDU session, a radio bearer (Signaling Radio Bearer (SRB) and/or Data Radio Bearer (DRB)), a Radio Link Control (RLC) bearer, and/or a logical channel.

An explicit configuration may be used for some traffic (or traffic type), and an implicit configuration (or pre-configuration) may be used for some (other) traffic (or traffic type). For example, whether a first traffic (or traffic type) is allowed to use S&F operation may be based on the configuration. Whether a second traffic (or traffic type) is allowed to use S&F operation may be based on a pre-configuration (e.g. allowed, not allowed, without configuration).

The UE may determine (whether) to use S&F operation (e.g. for a specific traffic or traffic type) based on (at least) the configuration. For example, if the UE receives the configuration and/or the traffic of the UE is included in the configuration (or pre-configuration), the UE may consider the S&F operation is (or is not) enabled (and/or activated, and/or allowed), e.g. for the traffic. If the UE receives the configuration and/or the traffic of the UE is not included in the configuration (or pre-configuration), the UE may consider the S&F operation is not (or is) enabled (and/or activated, and/or allowed), e.g. for the traffic. If the UE receives the configuration and/or the traffic of the UE could fulfill the condition/limitation/restriction/requirement of the configuration (or pre-configuration), the UE may consider the S&F operation is enabled (and/or activated, and/or allowed), e.g. for the traffic. If the UE receives the configuration and/or the traffic of the UE cannot fulfill the condition/limitation/restriction/requirement of the configuration (or pre-configuration), the UE may consider the S&F operation is not (or is) enabled (and/or activated, and/or allowed), e.g. for the traffic. If the UE does not receive the configuration, the UE may consider the S&F operation is (or is not) enabled (and/or activated, and/or allowed), e.g., for every (or all) traffic of the UE.

If the UE considers S&F operation is allowed/enabled/activated for a traffic, the UE may perform transmission (and/or reception) of the traffic (e.g., using S&F operation), initiate a procedure to (or for) performing transmission (and/or reception) of the traffic (e.g., using S&F operation), and/or request permission/establishment/resource for the traffic (e.g., using S&F operation). The procedure may be a registration procedure (e.g., for initial and/or mobility update), a service request procedure, a PDU session establishment (or modification) procedure.

### QoS Parameter

The parameter may be used by the UE (e.g., based on at least the parameter) to determine (at least) whether a QoS requirement of a UE request (e.g., for a service, a connection, a PDU session, and/or a QoS flow) can be fulfilled. The parameter may be used by the UE (e.g., based on at least the parameter) to (at least) determine whether to initiate a UE request (e.g., for a service, a connection, a PDU session, and/or a QoS flow).

The parameter may be (at least) based on (or identified by/represented by/specific to) a UE, a connection, a service, a PDU session, and/or a QoS flow. The configuration may (at least) indicate what type of UE, connection, service, PDU session, and/or QoS flow is associated to the parameter. The parameter may be (at least) based on (or identified by/represented by/specific to) a radio bearer (SRB and/or DRB), an RLC bearer, and/or a logical channel. The configuration may (at least) indicate what type of radio bearer, RLC bearer, and/or logical channel is associated to the parameter.

The parameter may be (or comprise) (at least) a QoS Flow Identifier (QFI), a 5G QoS Identifier (5QI), an Allocation and Retention Priority (ARP), a resource type, a priority level, a packet error rate, an averaging window, a delay budget (e.g. packet delay budget), and/or a data volume (maximum data burst volume).

The parameter may (at least) indicate a QoS (related) level/requirement/characteristic(s) allowed to use the S&F operation. The parameter may (at least) indicate a maximum QoS level (e.g. latency) that the NW can fulfill. The parameter may (at least) indicate how long the data (or signaling) received from a UE is expected to be stored by the NW before being delivered. The parameter may (at least) indicate how long the response of a UE request is (expected to be) transmitted (or received).

The UE may determine (whether) to use S&F operation (e.g. for a specific object, for a service, for a PDU session) based on (at least) the configuration. For example, if the UE receives the configuration and/or the object of the UE (or the service, or the PDU session) is included in the configuration (or pre-configuration), the UE may consider the S&F operation is (or is not) enabled (and/or activated, and/or allowed), e.g. for the object, for the service, and/or for the PDU session. If the UE receives the configuration and/or the object of the UE (or the service, or the PDU session) is not included in the configuration (or pre-configuration), the UE may consider the S&F operation is not (or is) enabled (and/or activated, and/or allowed), e.g. for the object, for the service, and/or for the PDU session. If the UE receives the configuration and/or the object of the UE (or the service, or the PDU session) could fulfill the condition/limitation/restriction/requirement of the configuration (or pre-configuration), the UE may consider the S&F operation is enabled (and/or activated, and/or allowed), e.g. for the object, for the service, and/or for the PDU session. If the UE receives the configuration and/or the object of the UE (or the service, or the PDU session) cannot fulfill the condition/limitation/restriction/requirement of the configuration (or pre-configuration), the UE may consider the S&F operation is not (or is) enabled (and/or activated, and/or allowed), e.g. for the object, for the service, and/or for the PDU session. If the UE does not receive the configuration, the UE may consider the S&F operation is (or is not) enabled (and/or activated, and/or allowed), e.g., for every (or all) object of the UE (or the service, or the PDU session).

If the UE considers S&F operation is allowed/enabled/activated for an object (or a service, or a PDU session), the UE may perform transmission (and/or reception) of the object (or the service, or the PDU session) (e.g., using the S&F operation), initiate a procedure to (or for) performing transmission (and/or reception) of the object (or the service, or the PDU session) (e.g., using the S&F operation), and/or to request permission/establishment/resource for the object (or the service, or the PDU session) (e.g., using the S&F operation). The procedure may be a registration procedure (e.g., for initial and/or mobility update), a service request procedure, a PDU session establishment (or modification) procedure.

To determine whether a service (or PDU session, or UE) is allowed to use S&F operation, at least an object of the service (or PDU session, or UE) needs to fulfill the configured QoS. For example, if no object of the service (or PDU session, or UE) fulfills the configured QoS, the UE may not be allowed to use the S&F operation for the service (or PDU session, or UE). If every object of the service (or PDU session, or UE) fulfills the configured QoS, the UE may be allowed to use the S&F operation for the service (or PDU session, or UE). If some object(s) of the service (or PDU session, or UE) (e.g. a first object) fulfills the configured QoS and some other object(s) of the service (or PDU session, or UE) (e.g. a second object) does not fulfill the configured QoS, the UE may be allowed to use the S&F operation for the first object and not allowed to use the S&F operation for the second object. If some object(s) of the service (or PDU session, or UE) (e.g. a first object) fulfills the configured QoS and some other object(s) of the service (or PDU session, or UE) (e.g. a second object) does not fulfill the configured QoS, the UE may not be allowed to use the S&F operation for the service (or PDU session, or UE) (e.g. including the first object and the second object). If some object(s) of the service (or PDU session, or UE) (e.g. a first object) fulfills the configured QoS and some other object(s) of the service (or PDU session, or UE) (e.g. a second object) does not fulfill the configured QoS, the UE may be allowed to use the S&F operation for the service (or PDU session, or UE) (e.g. including the first object and the second object).

The object may be (or comprise) (at least) a connection, a service, a PDU session, and/or a QoS flow. The object may be (or comprise) (at least) a radio bearer, an RLC bearer, and/or a logical channel.

### Data Volume

The configuration may (at least) indicate a data volume limitation allowed to use the S&F operation. The configuration may (at least) indicate how much data that can be transmitted to the NW (e.g., using the S&F operation). The data may be (or comprise) UP data and/or CP signaling. The data may be AS level and/or NAS level.

The configuration may be (at least) based on (or identified by/represented by/specific to) a UE, a connection, a service(s), a PDU session(s), and/or a QoS flow(s). The configuration may (at least) indicate what (or which) UE, connection(s), service(s), PDU session(s), and/or QoS flow(s) is associated to the configuration. The configuration may be (at least) based on (or identified by/represented by/specific to) a radio bearer(s) (SRB and/or DRB), an RLC bearer(s), and/or a logical channel(s). The configuration may (at least) indicate what (or which) radio bearer(s), RLC bearer(s), and/or logical channel(s) is associated to the parameter.

The UE may determine (whether) to use S&F operation (e.g. for a specific object) based on (at least) the configuration. The UE may determine (whether) to stop the S&F operation (e.g. for a specific object) based on (at least) the configuration. The UE may determine (whether) the S&F operation (e.g. for a specific object) can continue based on (at least) the configuration.

The object may be (or comprise) (at least) a UE, a connection, a service, a PDU session, and/or a QoS flow. The object may be (or comprise) (at least) a radio bearer, an RLC bearer, and/or a logical channel.

For example, if the UE receives the configuration and/or the traffic of the UE (e.g., for the object) has not exceeded the data volume, the UE may (be allowed to) use the S&F operation, e.g. for the traffic. If the UE receives the configuration and/or the traffic of the UE (e.g., for the object) has exceeded the data volume, the UE may not (be allowed to) use the S&F operation, e.g. for the traffic. If the UE does not receive the configuration, the UE may consider there is no data volume limitation to use the S&F operation, e.g., for the UE, for the object.

If the UE considers that S&F operation is allowed (e.g., for a traffic), the UE may perform (or continue) transmission (and/or reception) of the traffic (e.g., using the S&F operation), initiate (or continue) a procedure to (or for) performing transmission (and/or reception) of the traffic (e.g., using the S&F operation), and/or to request permission/establishment/resource for the traffic (e.g., using the S&F operation). The procedure may be a registration procedure (e.g., for initial and/or mobility update), a service request procedure, a PDU session establishment (or modification) procedure.

If the UE has transmitted data exceeding the data volume, the UE may stop the S&F operation, stop transmitting data, stop the (ongoing) procedure. If the UE has transmitted data exceeding the data volume, the UE may transmit an indication to the NW (e.g. indicating that the data volume limitation is reached), initiate a (RRC and/or NAS) connection release (request) procedure, initiate a de-registration procedure, and/or initiate a PDU session release (or modification) procedure (e.g., to release a PDU session). If the UE has transmitted data exceeding the data volume, the UE may release a (RRC and/or NAS) connection, and/or go to (RRC and/or NAS) idle mode (e.g., RRC_IDLE, Connection Management (CM)_IDLE).

The NW (or network node) may be a satellite NW. The satellite NW may be a network node, a CN node, a RAN node, an AMF, an SMF, an MME, a RAN, an NG-RAN, an eNB, a gNB, a base station, a portion of the above, and/or a combination of the above.

The NW (or network node) may be a ground NW. The ground NW may be a network node, a CN node, a RAN node, an AMF, an SMF, an MME, a RAN, an NG-RAN, an eNB, a gNB, a base station, a portion of the above, and/or a combination of the above.

The satellite NW and the ground NW may be mutually exclusive.

The NW (or network node) may be a cell. The NW may be a serving cell. The NW may be a neighbor cell. The NW may be a source cell. The NW may be a target cell.

The UE may support S&F operation. The UE may not support S&F operation.

The UE may be in RRC connected mode. The UE may be in RRC idle mode. The UE may be in RRC inactive mode.

The UE may be in a CM idle state. The UE may be in a CM connected state.

The UE may be in a Registration Management (RM) deregistered state. The UE may be in an RM registered state.

The UE may be in a cell of an NTN. The UE may be connected to a cell of an NTN. The UE may be connected to a LEO, a GEO, an MEO, an HEO, and/or a HAPS.

The UE may be referred to as the UE, an RRC entity of the UE, or a Medium Access Control (MAC) entity of the UE.

The UE may be an NR device. The UE may be an NR-light device. The UE may be a reduced capability device. The UE may be a mobile phone. The UE may be a wearable device. The UE may be a sensor. The UE may be a stationary device.

The NW may be a network node. The NW may be a base station. The NW may be an access point. The NW may be an eNB. The NW may be a gNB. The NW may be a gateway.

Various examples and embodiments of the present invention are described below. For the methods, alternatives, concepts, examples, and embodiments detailed above and herein, the following aspects and embodiments are possible.

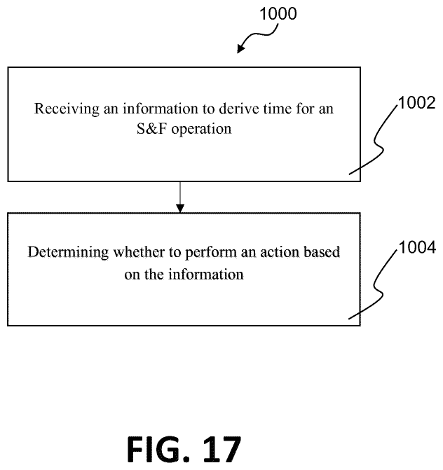

Referring to FIG. 17, with this and other concepts, systems, and methods of the present invention, a method 1000 for a UE in a wireless communication system comprises receiving an information to derive time for an S&F operation (step 1002), and determining whether to perform an action based on the information (step 1004).

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) receive an information to derive time for an S&F operation; and (ii) determine whether to perform an action based on the information. Moreover, the CPU 308 can execute the program code 312 to perform all of the described actions, steps, and methods described above, below, or otherwise herein.

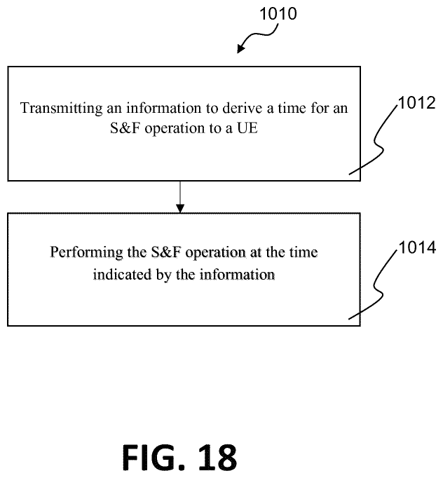

Referring to FIG. 18, with this and other concepts, systems, and methods of the present invention, a method 1010 for a first network node in a wireless communication system comprises transmitting an information to derive a time for an S&F operation to a UE (step 1012), and performing the S&F operation at the time indicated by the information (step 1014).

Referring back to FIGS. 3 and 4, in one or more embodiments from the perspective of a first network node in a wireless communication system, the device 300 includes a program code 312 stored in memory 310 of the transmitter. The CPU 308 could execute program code 312 to: (i) transmit an information to derive a time for an S&F operation to a UE; and (ii) perform the S&F operation at the time indicated by the information. Moreover, the CPU 308 can execute the program code 312 to perform all of the described actions, steps, and methods described above, below, or otherwise herein.

In various embodiments, the information includes a (expected) time to start the S&F operation.

In various embodiments, the information includes a (expected) time to end the S&F operation.

In various embodiments, the information includes a (expected) duration of the S&F operation.

In various embodiments, the action includes starting (or stopping) applying the S&F operation.

In various embodiments, the action includes applying (or releasing) an S&F configuration.

In various embodiments, the action includes allowing (or prohibiting) a non-S&F data transmission.

In various embodiments, the action includes allowing (or prohibiting) a specific procedure.

In various embodiments, the specific procedure includes a registration procedure.

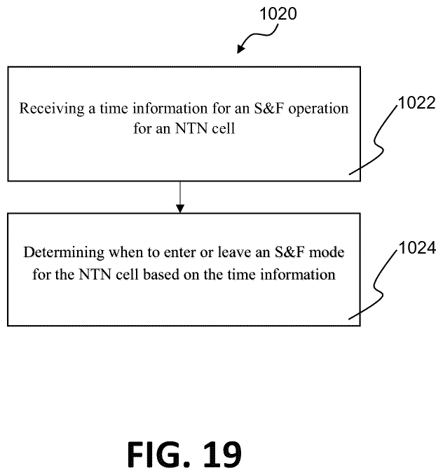

Referring to FIG. 19, with this and other concepts, systems, and methods of the present invention, a method 1020 for a UE in a wireless communication system comprises receiving a time information for an S&F operation for an NTN cell (step 1022), and determining when to enter or leave an S&F mode for the NTN cell based on the time information (step 1024).

In various embodiments, the time information is provided in system information

In various embodiments, the time information comprises a time to enter the S&F mode, a time to leave the S&F mode, and/or a duration of the S&F mode.

In various embodiments, a value of the time information is an absolute time or relative to a time reference.

In various embodiments, the method further comprises deriving a remaining time of the S&F operation based on the time information.

In various embodiments, the method further comprises determining when to enter or leave the S&F mode based on the time information.

In various embodiments, the method further comprises determining whether to allow a connection establishment to the NTN cell based on the time information.

In various embodiments, the method further comprises determining whether to request one or more uplink resources (e.g., for non-S&F data) based on the time information.

In various embodiments, the time information is received from a network node.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) receive a time information for an S&F operation for an NTN cell; and (ii) determine when to enter or leave an S&F mode for the NTN cell based on the time information. Moreover, the CPU 308 can execute the program code 312 to perform all of the described actions, steps, and methods described above, below, or otherwise herein.

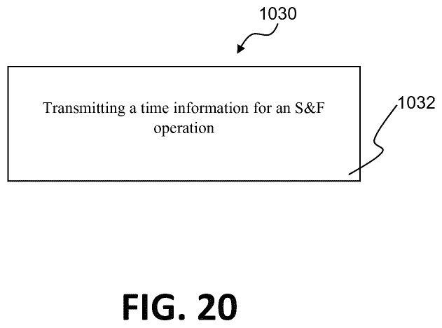

Referring to FIG. 20, with this and other concepts, systems, and methods of the present invention, a method 1030 for an NTN cell in a wireless communication system comprises transmitting a time information for an S&F operation (step 1032).

In various embodiments, the NTN cell provides the S&F operation at a time indicated or derived by the time information.

In various embodiments, the time information is transmitted to a User Equipment (UE).

Referring back to FIGS. 3 and 4, in one or more embodiments from the perspective of an NTN cell in a wireless communication system, the device 300 includes a program code 312 stored in memory 310 of the transmitter. The CPU 308 could execute program code 312 to: (i) transmit a time information for an S&F operation. Moreover, the CPU 308 can execute the program code 312 to perform all of the described actions, steps, and methods described above, below, or otherwise herein.

Any combination of the above or herein concepts or teachings can be jointly combined, in whole or in part, or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for a User Equipment (UE), comprising:
receiving a time information for a Store and Forward (S&F) operation for a Non-Terrestrial Network (NTN) cell; and
determining when to enter or leave an S&F mode for the NTN cell based on the time information.

2. The method of claim 1, wherein the time information is provided in system information.

3. The method of claim 1, wherein the time information comprises a time to enter the S&F mode, a time to leave the S&F mode, and/or a duration of the S&F mode.

4. The method of claim 1, wherein a value of the time information is an absolute time or relative to a time reference.

5. The method of claim 1, further comprising deriving a remaining time of the S&F operation based on the time information.

6. The method of claim 1, further comprising determining when to enter or leave the S&F mode based on the time information.

7. The method of claim 1, further comprising determining whether to allow a connection establishment to the NTN cell based on the time information.

8. The method of claim 1, further comprising determining whether to request one or more uplink resources based on the time information.

9. The method of claim 1, wherein the time information is received from a network node.

10. A method for a Non-Terrestrial Network (NTN) cell, comprising:
transmitting a time information for a Store and Forward (S&F) operation.

11. The method of claim 10, wherein the NTN cell provides the S&F operation at a time indicated or derived by the time information.

12. The method of claim 10, wherein the time information is transmitted to a User Equipment (UE).

13. A User Equipment (UE), comprising:
a memory; and
a processor operatively coupled to the memory, wherein the processor is configured to execute a program code to:
receive a time information for a Store and Forward (S&F) operation for a Non-Terrestrial Network (NTN) cell; and
determine when to enter or leave an S&F mode for the NTN cell based on the time information.

14. The UE of claim 13, wherein the time information is provided in system information.

15. The UE of claim 13, wherein the time information comprises a time to enter the S&F mode, a time to leave the S&F mode, and/or a duration of the S&F mode.

16. The UE of claim 13, wherein a value of the time information is an absolute time or relative to a time reference.

17. The UE of claim 13, wherein the processor is further configured to execute the program code to derive a remaining time of the S&F operation based on the time information.

18. The UE of claim 13, wherein the processor is further configured to execute the program code to determine when to enter or leave the S&F mode based on the time information.

19. The UE of claim 13, wherein the processor is further configured to execute the program code to determine whether to allow a connection establishment to the NTN cell based on the time information.

20. The UE of claim 13, wherein the processor is further configured to execute the program code to determine whether to request one or more uplink resources based on the time information.
